(19) United States
(12) Patent Application Publication
(10) Pub. No.: US 2011/0290338 A1
(43) Pub. Date: Dec. 1, 2011

(54) WATER SUPPLY SYSTEM UTILIZING COLLECTED STORED WATER AND MAINS WATER SUPPLY

(76) Inventors: Ugo Beltrami, Blackburn (AU); David Beltrami, Blackburn (AU); Antonio Beltrami, Blackburn (AU)

(21) Appl. No.: 13/149,111

(22) Filed: May 31, 2011

(30) Foreign Application Priority Data
May 28, 2010 (AU) 2010202174

(51) Int. Cl. G05D 7/00; G05D 11/00

(52) U.S. Cl. 137/113; 137/115.13

(57) ABSTRACT

The specification discloses a valve arrangement (18) for directing water to an end user (24) from either a first source (22) such as a mains pressure water supply or a second source (23) such as a pump means (14) discharging water from water collected in a storage tank (12), the valve arrangement (18) including a first valve (25, 45) positionable in at least a first position or a second position for connecting or disconnecting respectively at least the first source (22) to or from the end user (24), the valve arrangement (18) further including an actuator (28) for positioning the first valve (25, 45) selectably in at least one of said first or said second positions, the actuator (28) being actuated by pressurized water from said second source (23) to move said first valve (25, 45) to at least one of said first or said second positions via a first communication flow passage (31) communicating with said second source (23), and a dump valve (35) in the first communication flow passage (31) permitting flow of pressurized water from said second source (23) to said actuator (28), the dump valve (35) permitting discharge of at least part of the water from the first communication flow passage (31) in the absence of the pressurized water from said second source (23).

### CROSS-REFERENCE TO RELATED APPLICATION

The present application claims priority under 35 U.S.C. 119 from Australian Patent Application No. 2010202174, filed on May 28, 2010, the contents of which are incorporated herein by reference.

### FIELD OF INVENTION

The present invention relates to improvements in systems for supplementing mains water supply to domestic and commercial buildings with collected water typically in storage tanks or the like.

### BACKGROUND OF THE INVENTION

In the current climatic environment and increasing water usage requirements, water is becoming an increasingly scarce and expensive commodity. It is therefore more common to install rainwater collection and storage tanks with both new and existing buildings to provide a useful supplement for the conventional mains water supply. As a result, a convenient, simple and inexpensive control device for interfacing mains water supply with a locally collected and stored water supply is necessary. Such a system is known, for example, in Australian innovation patent specification no. 2008100676. Such interfacing means, apart from operating conveniently, simply and efficiently, need also to prevent water from the locally collected source getting back into the mains supply system to protect that system from possible undesirable contaminants.

The objective of the present invention is to provide a simple and effective interface arrangement that will enable water from a mains supply and from a locally collected water source to be used by a user while protecting the mains source from any possible contamination from the locally collected water source.

### SUMMARY OF THE INVENTION

According to the present invention, there is provided a valve arrangement for directing water to an end user from either a first source or a second source, said valve arrangement including a first valve means positionable in at least a first or a second position for connecting or disconnecting respectively at least said first source to or from said end user, actuator means for positioning said first valve means selectably in at least one of said first or said second positions, said actuator being actuated by pressurized water from said second source to move said first valve means to at least one of said first or said second positions via a first communication flow passage communicating with said second source, and a dump valve means in said first communication flow passage permitting flow of pressurized water from said second source to said actuator, said dump valve means permitting discharge of at least part of the water from said first communication flow passage in the absence of said pressurized water from said second source. The valve arrangement may further include first connection means enabling connection of the valve arrangement to a mains pressure water supply forming said first source, and a second connection means enabling connection of the valve arrangement to pressurized water from a collection water storage tank forming said second source. Conveniently the valve arrangement may further include third connection means enabling connection of the valve arrangement to said end user, the end user being an end use water reticulation system. Preferably, the reticulation system will in use be installed in a domestic or commercial building. The arrangement provides a simple and effective means for enabling collected water in a storage tank (eg rain water) to be used in substitution for mains water while sufficient collected water exists in the storage tank. When the water in the storage tank drops to a level unsafe for further use, the system switches automatically back to the mains water supply without the need for electrical connections or mechanical drive means operated from a separate power source.

Preferred features and aspects of the invention may be as defined in claims 4 to 13 inclusive as annexed hereto. The subject matter of these claims are incorporated in the disclosure of this specification by this reference thereto.

The invention also anticipates providing a water supply system including at least one valve arrangement as described above.

Several preferred embodiments of the present invention will hereinafter be described with reference to the accompanying drawings.

### BRIEF DESCRIPTION OF THE DRAWINGS

FIG. 1 is a schematic elevation view of a water supply system including a collected water storage tank and a means water supply in a first mode of operation;

FIG. 2 is a schematic elevation view of part of FIG. 1 90° transposed relative to FIG. 1;

FIG. 3 is a schematic elevation view of a water supply system similar to FIG. 1 but in a second mode of operation;

FIG. 4 is a schematic elevation view of part of FIG. 3 90° transposed relative to FIG. 3;

FIG. 5 is a schematic section view of apparatus according to a first preferred embodiment of the present invention where water is supplied from the mains supply;

FIG. 6 is a schematic section view similar to FIG. 5 wherein water is supplied from the collected water storage;

FIGS. 7a and 7b are section views of alternative preferred embodiments of a water dumping valve usable in the present invention;

FIG. 8 is a section view of a second preferred embodiment according to the present invention where the mains water supply is open;

FIG. 9 is a further section view (different to FIG. 8) of the embodiment shown in FIG. 8 where the mains water supply is open;

FIG. 10 shows a section view of the second preferred embodiment shown in FIG. 8 but with the mains water supply closed; and

FIG. 11 is a further section view of the second preferred embodiment similar to FIG. 9 but where the mains water supply is closed.

### DETAILED DESCRIPTION OF THE INVENTION

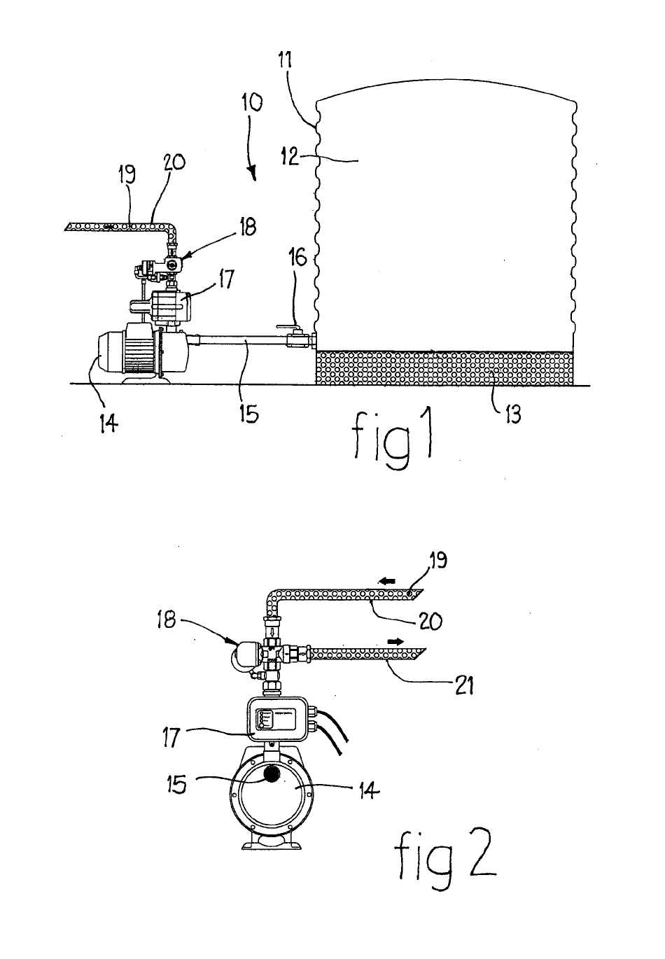

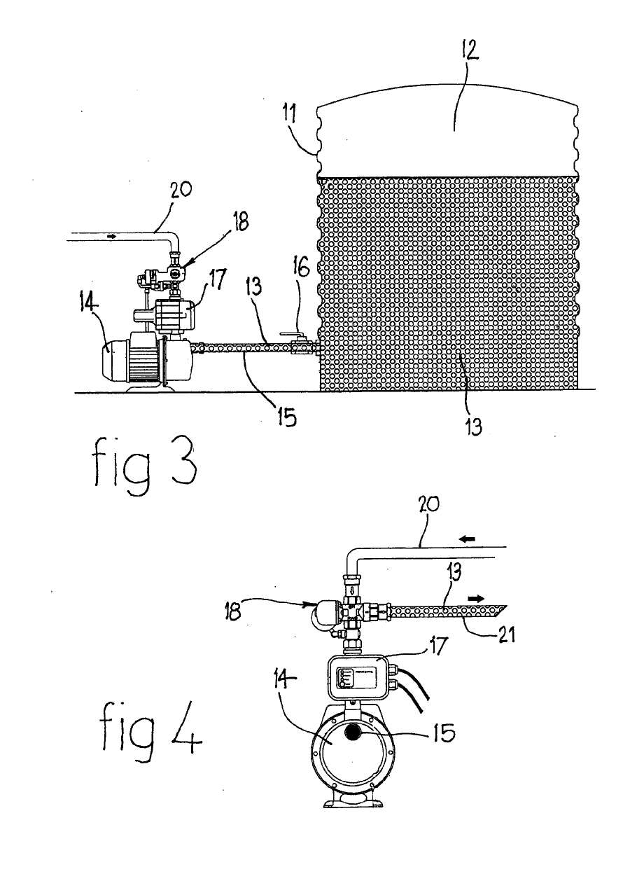

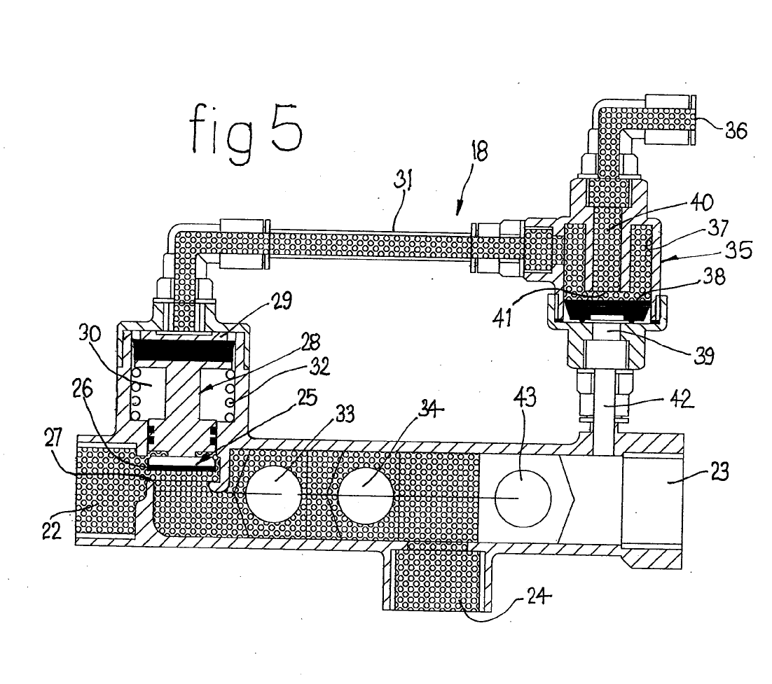

Referring to FIG. 1, the water supply system 10 includes a locally collected water storage device 11 in the form of a tank 12. The tank 12 receives collected rain water 13 via any suitable collection means and stores same until it is used as may be required from time to time. The system 10 further includes a pump 14 receiving rain water 13 via pipe 15 from the tank 12. The pipe 15 may include a manual valve 16. The pump 14 may be operated via a float sensor or similar water level sensing device (not shown) in the tank 12 such that when there is sufficient water 13 in the tank 12, the pump is operated to supply same and when there is insufficient water 13 in the tank 12 (as represented in FIG. 1), the pump 14 is turned off and water from the mains supply 20 is used. Any suitable pressure controller device 17 may be provided controlling the pressure of water supplied from the pump 14 to a controller valve arrangement 18 as described in greater detail in the following. Mains water 19 from the mains supply 20 is also delivered to the controller valve arrangement 18 such that, as described hereafter, the controller valve arrangement determines which water 13 or 19 is supplied to the end user 21 (house or other building). In FIGS. 1, 2 water 19 is being supplied from the mains supply 20 to the end user 21. FIGS. 3, 4 show the same arrangement in a different mode of operation where the tank 12 contains sufficient water and water 13 from the tank 12 is supplied to the end user 21.

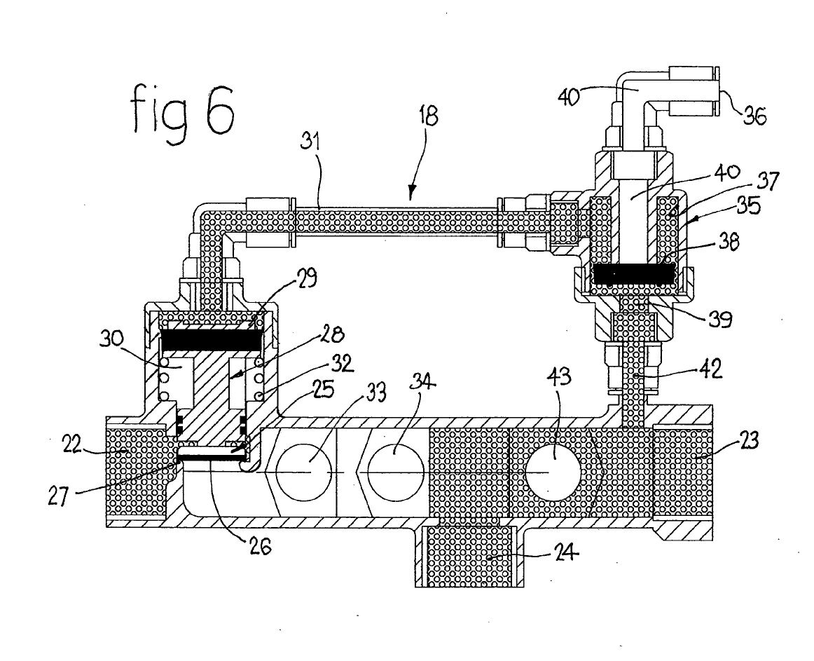

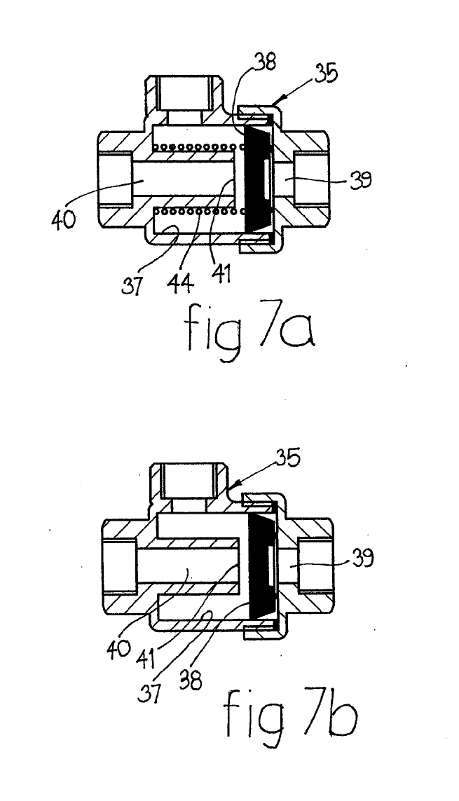

FIGS. 5, 6 show a first preferred embodiment of the controller valve arrangement 18 in first and second modes of operation. The controller valve arrangement 18 includes a first inlet means 22 enabling connection to the mains supply 20, a second inlet means 23 enabling connection to the discharge from the pump 14 and pressure controller 17, and an outlet means 24 for connection to the end user 21, the outlet means 24 being positioned to receive water flow from either of the inlet means 22 or 23. The first inlet means 22 communicates with a flow control valve 25 with a seal 26 cooperating with a seal seat 27. The seal 26 is moved towards or away from the seal seat 27 by an actuator 28. The actuator 28 includes a piston member 29 operating in a cylinder 30 such that water pressure at a certain level in the connector pipe 31 will act on the piston member 29 to move it downwardly in the cylinder 30 against the return spring 32 to engage the seal 26 against the seal seat 27. When this occurs no further water 19 from the mains supply 20 passes the flow control valve 25. If desired, a small vent aperture may be provided in the cylinder wall 30 to allow air to escape as the piston member 29 moves downwardly however, this is optional as the arrangement will also work without such a vent hole.

The controller valve arrangement 18 includes a pair of in line one way valves 33, 34 between the flow control valve 25 and the outlet means 24. The valves 33, 34 allow water flow only towards the outlet means 24 but not in a reverse direction. When the pump 14 and pressure controller 17 are not supplying water because the tank water 13 level is too low or loss of power to the pump 14 occurs, the spring 32 moves the actuator 28 to the position shown in FIG. 5 allowing mains water 19 to flow to the outlet means 24. At the same time a small amount of water in the connector pipe 31 is forced via the dumping valve 35 to a discharge port 36. The dumping valve 35 includes a cylindrical chamber 37 with a floating seal member 38 movable axially a short distance within the cylindrical chamber 37. The dumping valve 35 has an axial lower passage 39 sealed by the seal member 38 in its lower extremity of movement (FIG. 5) and an internal passage 40 leading to the discharge port 36. The inner lower end 41 of the internal passage 40 defines the upper extremity of movement of the seal member 38 and in this upper position, the seal member 38 closes the entry to the passage 40 leading to the discharge port 36.

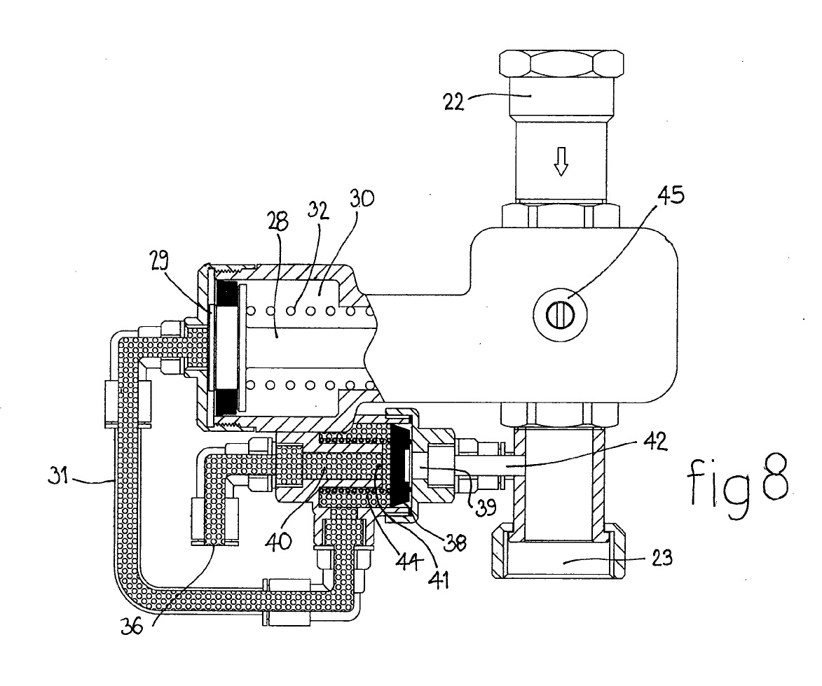

As shown in FIG. 6, if there is sufficient rain water 13 in the storage tank 12, the water 13 is delivered via pump 14 and the pressure regulator 17 to the inlet means 23. This water 13 is also delivered via the connecting passage 42 to the lower passage 39 of the dumping valve 35. The valve member 38 is moved to the position shown in FIG. 6 closing the passage 40 and sending pressurized water via the connector pipe 31 to the top of the piston member 29 to force same downwardly with the seal 26 closing onto the seal seat 27 to close the mains supply 20 and mains water 19 from the outlet means 24. The valve arrangement 18 may also include a one way valve 43 that permits water to flow only towards the outlet means 24 and not in a reverse direction. The seal member 38 is conveniently a cup shaped member and may include a spring member 44 (FIG. 7a) to urge the seal member 38 downwardly (FIGS. 5, 6) and to assist movement of the seal member 38 to the lower seal position shown in FIGS. 5 and 7a. The spring member 44 is not, however essential and the arrangement will also work without any such urging force as shown in FIGS. 5, 6 and 7b.

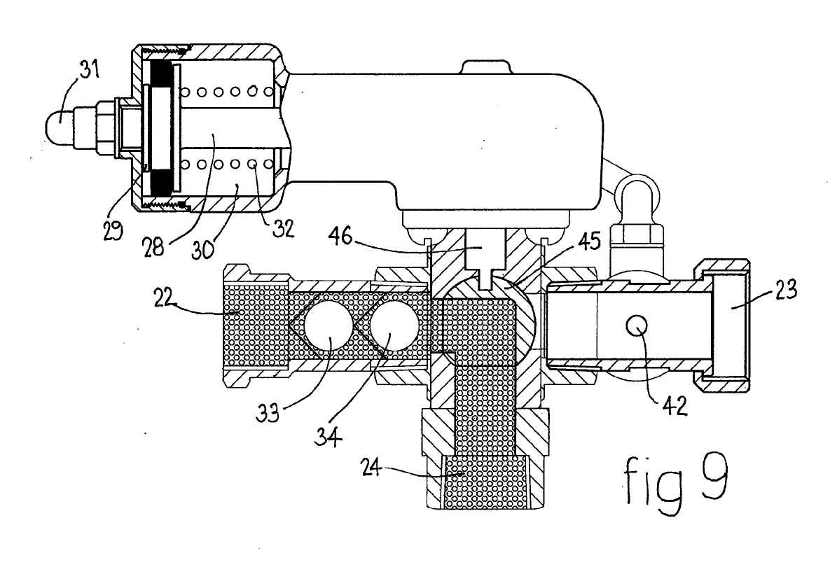

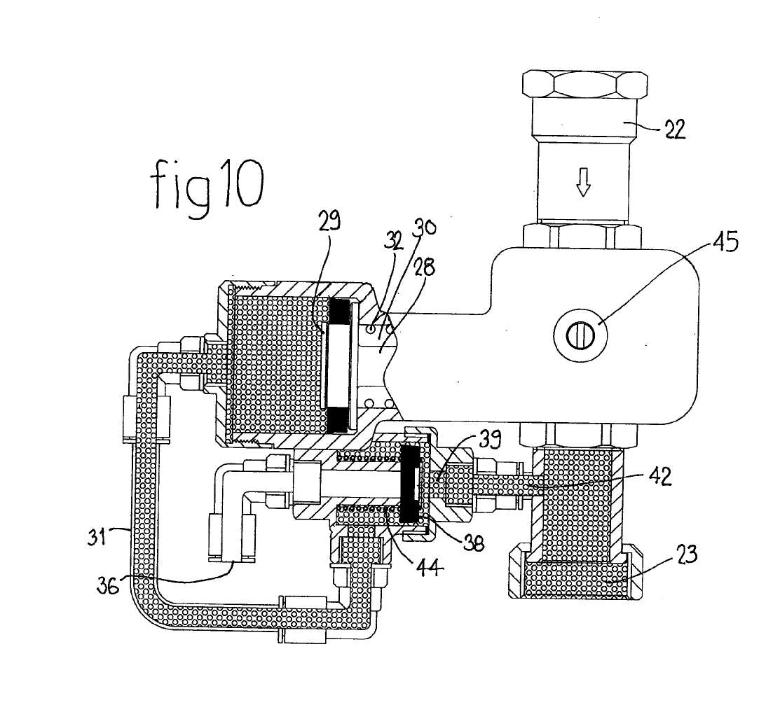

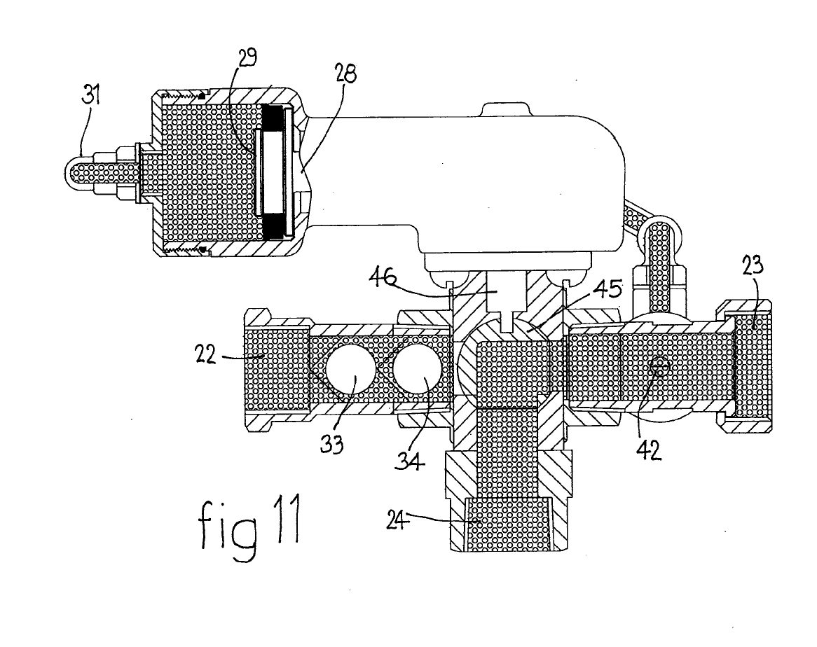

FIGS. 8, 9, 10 and 11 illustrate a second preferred embodiment in various modes of operation where like features have been given the same reference number. In this embodiment, the actuator 28 drives a rotating valve member 45 between one position when the first inlet means 22 is connected to the outlet 24 and a second position where the second inlet means 23 is connected to the outlet 24. The end of the actuator 28 opposite to the piston member 29 may, through a rack and pinion mechanism (not illustrated) rotate a drive shaft 46 to selectably rotate the valve member 45. Apart from this difference operation of this embodiment is the same as that described above with reference to FIGS. 5 and 6. In this embodiment, because of the structure of the rotary valve member 45 it is possible to omit the one way (non-return) valve 43 between the inlet means 23 and the end user outlet 24. Those skilled in this art will recognize that other valve structures could also be utilized for directing water from the mains inlet 22 on the rain water inlet 23 selectably to the end user outlet 24.

Those skilled in the art will recognize that other modifications and variations are possible without departing from the spirit of the invention defined in the accompanying claims.

Although the present invention has been described with reference to preferred embodiments, workers skilled in the art will recognize that changes can be made in form and detail without departing from the spirit and scope of the present invention.

What is claimed is:

1. A valve arrangement for directing water to an end user from either a first source or a second source, said valve arrangement including a first valve means positionable in at least a first or a second position for connecting or disconnecting respectively at least said first source to or from said end user, actuator means for positioning said first valve means selectably in at least one of said first or said second positions, said actuator being actuated by pressurized water from said second source to move said first valve means to at least one of said first or said second positions via a first communication flow passage communicating with said second source, and a dump valve means in said first communication flow passage permitting flow of pressurized water from said second source to said actuator, said dump valve means permitting discharge of at least part of the water from said first communication flow passage in the absence of said pressurized water from said second source.

2. A valve arrangement according to claim 1 further including first connection means enabling connection of the valve arrangement to a mains pressure water supply forming said first source, and a second connection means enabling connection of the valve arrangement to pressurized water from a collection water storage tank forming said second source.

3. A valve arrangement according to claim 2 further including third connection means enabling connection of the valve arrangement to said end user, the end user being an end use water reticulation system.

4. A valve arrangement according to claim 1 wherein said actuator means selectably positions said both of said first or said second positions.

5. A valve arrangement according to claim 1 wherein pressurized water from said second source moves said actuator to move said first valve means to said second position, said first valve means including a return spring means for moving said actuator to said first position in the absence of said pressurized water from said second source.

6. A valve arrangement according to claim 1 wherein pressurized water from said second source moves said actuator to move said first valve means to said first position, said first valve means including a return spring means for moving said actuator to said second position in the absence of said pressurized water from said second source.

7. A valve arrangement according to claim 1 wherein said actuator directly moves said first valve means in a linear motion between said first and said second positions.

8. A valve arrangement according to claim 1 wherein said first valve means moves rotatably between said first and said second positions.

9. A valve arrangement according to claim 8 wherein said actuator further includes an operating mechanism for converting linear motion to rotary motion.

10. A valve arrangement according to claim 1 further including at least one non return valve positioned in said valve arrangement between said first source and said end user whereby water can only flow towards said end user but not in a reverse direction.

11. A valve arrangement according to claim 1 further including at least one non return valve positioned in said valve arrangement between said second source and said end user whereby water can only flow towards said end user but not in a reverse direction.

12. A valve arrangement according to claim 1 wherein said dump valve means includes a cylindrical chamber, a first discharge passage leading into and partially axially along said cylindrical chamber defining at one end an external discharge port and at its opposed inner end, a first valve seat, a second valve seat axially spaced from said first valve seat surrounding an opening in an axial end wall of said cylindrical chamber communicating with said second source, and a floating valve member adapted, in use, to move axially in said cylindrical chamber to cooperate with said first and said second valve seats in alternative axial positions of said floating valve member.

13. A valve arrangement according to claim 12 further including spring means to urge said floating valve member towards said second valve seat.

14. A water supply system including at least one valve arrangement according to claim 1.
